(19) United States
(12) Patent Application Publication
(10) Pub. No.: US 2025/0278353 A1
(43) Pub. Date: Sep. 4, 2025

(54) ORCHESTRATION AND CONTINUOUS IMPROVEMENT OF SELF-REFERENCING DETECTION IN CHATBOTS

(71) Applicant: Dell Products L.P., Round Rock, TX (US)

(72) Inventors: Roberto Nery Stelling Neto, Rio de Janeiro (BR); Vicente J.P. Amorim, João Monlevade (BR); Vinicius Michel Gottin, Rio de Janeiro (BR)

(21) Appl. No.: 18/591,659

(22) Filed: Feb. 29, 2024

(51) Int. Cl. G06F 11/36; G06F 16/21

(52) U.S. Cl. CPC G06F 11/3684; G06F 16/217

(57) ABSTRACT

Prompt engineering and context management in applications. A chatbot is configured to generate a response to a query. Context management in the chatbot uses a prompt instance and a model to determine whether a current query references a reference query. The output of the model may impact the input provided to a model that generates a response to a user's query. A database of queries is used in prompt engineering and to test multiple models to identify a combination of a prompt instance/model to be deployed to the application.

### FIELD OF THE INVENTION

Embodiments of the present invention generally relate to context management. More particularly, at least some embodiments of the invention relate to systems, hardware, software, computer-readable media, and methods for orchestrating self-referencing detection in machine learning based chatbots.

### BACKGROUND

A chatbot is one of the ways that an entity may interact with a user. Chatbots are often used to provide customer service, engage with the customer, encourage sales, perform troubleshooting, or the like. When accessing a website (e.g., a help section of the website), for example, a chatbot often appears. Using the chatbot, a user is able to communicate with the entity and submit questions or queries.

A chatbot may be automated or include automated aspects. Automated chatbots are often successful at collecting basic information such as a user's name, account number, and product. The chatbot may even ask for a description of the user's issue. Automated chatbots, however, are not nearly as successful when it comes to maintaining a conversation with the user and fully resolving their concern and this is due, in part, to the lack of adequate context management.

Context management relates to procedures and processes that attempt to provide semantic coherence between the user's subsequent interactions with the chatbot during a conversation. This is proving difficult because queries can pose problems that are difficult for a chatbot to interpret. More specifically, a chatbot may, in addition to other approaches, perform context management using a topic identification or key word approach. Using topic information or key words extracted from a query, an attempt is made to provide an automated response. However, the automated response is often unsatisfactory. By way of example, it is difficult to detect a context switch in a user's line of queries in a conversation. Consequently, a typical concern with chatbot technology relates to providing relevant responses in the context of a conversation that may have multiple user queries.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a chatbot configured with context management;

FIG. 1B discloses additional aspects of a chatbot configured with context management;

FIG. 2 discloses aspects of context management including self-referencing detection;

FIG. 3 discloses aspects of a benchmark dataset or database;

FIG. 4 discloses aspects of generating cases configured for use in defining prompts and selecting models for context management;

FIG. 5 discloses aspects of evaluating cases generated using a benchmark database;

FIG. 6 discloses additional aspect of evaluating cases and of selecting a model for use in context management; and

FIG. 7 discloses aspects of a computing device, system, or entity.

### DETAILED DESCRIPTION OF SOME EXAMPLE EMBODIMENTS

Embodiments of the present invention generally relate to context management in applications including user-interactive applications. More particularly, at least some embodiments of the invention relate to systems, hardware, software, computer-readable media, and methods for self-referencing detecting in large language model-based applications and to prompt engineering in applications including chatbots.

Embodiments of the invention are described in the context of chatbots but may be implemented in other scenarios/applications that may require context management for user/AI interactions or other machine learning based conversations or interactions.

Embodiments of the invention relate to self-referencing detection in automated (e.g., user/AI (Artificial Intelligence)) conversations. As used herein, self-referencing detection includes, but is not limited to, determining whether a current query is related to a reference query, automatically determining whether a change in subject has occurred in a conversation, selecting a reference question, identifying follow-up questions, or the like or combinations thereof.

A user may interact with a chatbot in various manners including a user interface, REST API, or the like. Embodiments of the invention are discussed in the context of a user interface but are not limited thereto. When a user interacts with a chatbot, the user formulates a query or question that is submitted in the user interface presented to the chatbot. The chatbot receives the query and generates a response. In one example, a large language model, which may be trained for a relevant domain, is used to generate the response to the user's query. Embodiments of the invention receive the user's query and then process the query to generate a prompt, which typically includes the user's query or a representation of the user's query, that is input to the large language model.

Generating a prompt is difficult due to the ambiguous nature of user queries. Further, the prompt may influence the response generated and part of context management includes engineering a prompt that is likely to result in more relevant results. Embodiments of the invention relate to a self-reference detection system that is configured to generate or identify a prompt that is more likely to generate a relevant response to the user's query.

More specifically, embodiments of the invention further relate to a system configured to engineer the parts or components of the prompt used by the chatbot to query to large language model. For example, engineering the prompt may influence the sources used by the large language model to generate an output. Engineering the prompt may be performed in conjunction with selecting a model that is configured to determine whether the query is a self-referencing query prior to querying the large language model.

Embodiments of the invention may also include aspects of determining whether a current query is related to a reference query (e.g., a most recent query) or of determining whether the user's current query represents a change in subject or context. The ability to detect these types of scenarios helps ensure that the response generated by the chatbot is more likely to be relevant.

Embodiments of the invention relate to self-referencing detection in queries received by a chatbot and to context management that accounts for self-referencing queries. The ability to detect self-referencing queries can improve the conversation or responses provided by the chatbot and may have synergy with conventional approaches to context management such as topic identification.

Context management relates to monitoring aspects of user/Al conversations and providing or managing the resources that support context management. Embodiments of the invention relate to identifying self-referencing questions, follow-up conversation, or the like. Embodiments of the invention relate to evaluating multiple models (e.g., large language models) in order to determine which is most likely to correctly identity a self-referencing query.

Embodiments of the invention relate to detecting self-referencing questions and may also use a prompt-engineered invocation of an auxiliary machine learning model to determine whether a current query references a previous or reference query. The prompt, in one example, is engineered for use with a model configured to predict whether a query is self-referencing with respect to a reference query and may also be used to query the large language model used by the chatbot to generate a response to the query.

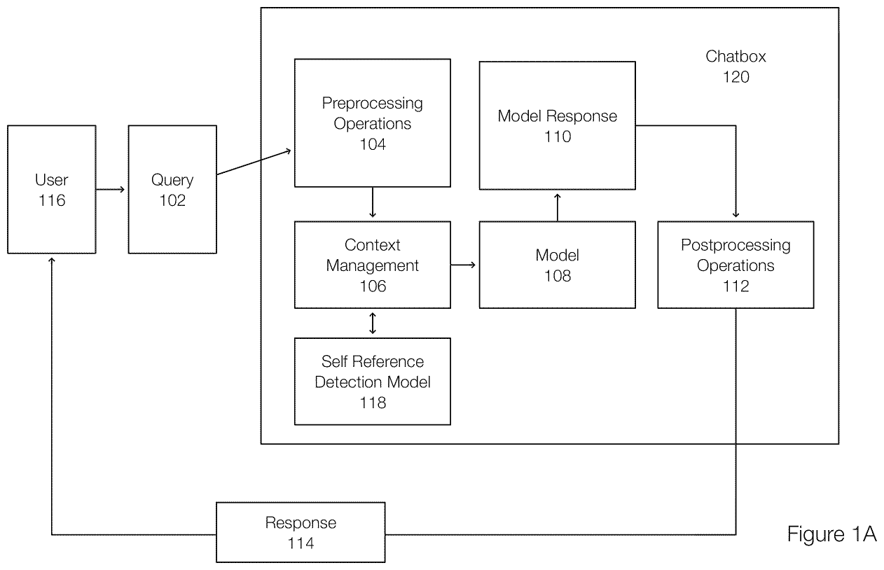

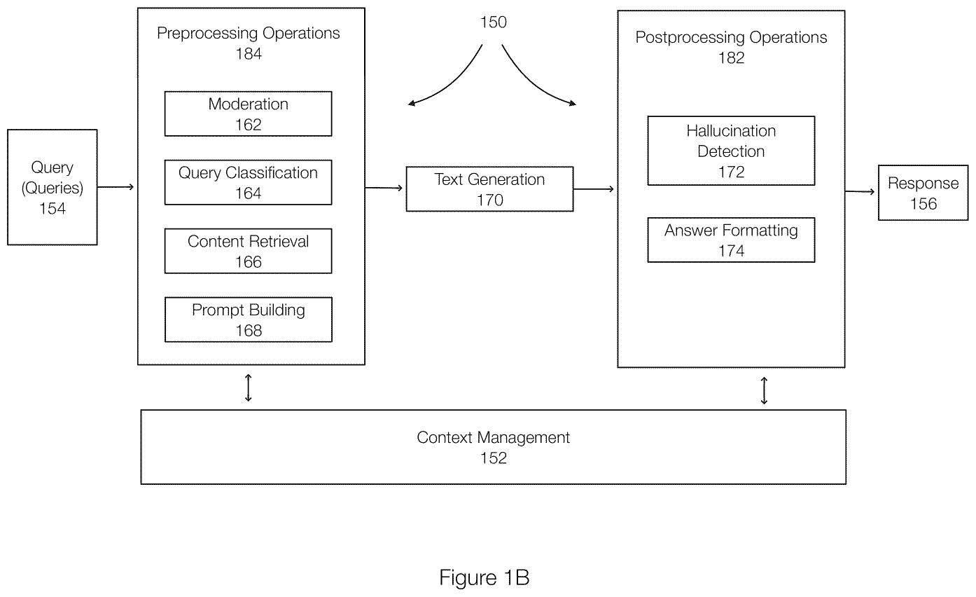

FIG. 1A discloses aspects of a chatbot that includes context management. FIG. 1A illustrates a cloud-based chatbot 120 that is configured to conduct “conversations” with a user 116. The chatbot 120 receives a query 102 from the user 116 and returns a response 114 to the user 116. The chatbot 120 may be embodied as a server, physical or virtual, and include a processor, memory, and the like.

More specifically, the chatbot 120 receives the query 102 and performs preprocessing operations 104. One of the preprocessing operations 104 is context management 106. In this example, context management 106 includes determining whether the query 102 is a self-referencing query (e.g., references a previous query). This allows a prompt to be generated that accounts for the self-referencing aspect of the query. Once a prompt is generated, a self-referencing detection model 118 is queried and a response from the model 118 is a prediction. The response from the model 118 may be true if the model predicts that the query 102 is self-referencing or false if the model 118 predicts that the query 102 is not self-referencing. The prediction may impact the manner in which the query 102 is presented to the model 108.

The query 102, along with this context information, is used by the model 108 to generate a model response 110. The chatbot 118 may perform postprocessing operations 112 (e.g., formatting, hallucination detection) on the model response 110 to generate the response 114 prior to providing the response 114 back to the user 116.

FIG. 1B discloses additional aspects of a chatbot with context management that includes self-referencing detection. The chatbot 150, which is an example of the chatbot 120, may include context management 152, represented as a context management pipeline. The chatbot 150 receives a query 154 as input (e.g., a question or other input (text, audio) from a user). The query 154 is processed and the chatbot 150 may generate a response 156. This process may repeat as additional queries 154 are received by the chatbot 150. The queries from the user and responses from the chatbot 150 are an example of user/AI conversations.

The context management 152 may include preprocessing operations 184 that are performed before generating text 170 and postprocessing operations 182 that are performed after generating text 170. The operations 184 may include moderation 112, query classification 164, content retrieval 166, and prompt building 168. Moderation 162 may relate to content filtering (e.g., related to community guidelines), rule enforcement, and the like. Query classification 164 may relate to categorizing the query 102. Query classification 164 may influence the sources used to generate text 170. Prompt building 168 relates to the process of generating a prompt or query used as input to a self-detection model for context management. The self-detection model and the model used to generate the response 156 may be the same model in some embodiments. Content retrieval 166 relates to the process of querying the large language model.

Text generation 170 relates to generating the text that is responsive to the query 154 and generally corresponds to the output of the large-language model used by the chatbot 150. Once the text is generated 170, postprocessing operations 182 are performed. The postprocessing operations 182 include hallucination detection 172 and answer formatting 174. Hallucination detection 172 ensures that the answer does not include erroneous information. This may include accessing other sources to verify the information included in the response 156. Answer formatting 174 relates to formatting the response 156 for delivery to the user.

The context management 152 is configured to determine a context of the text generation 170 or of the query 154. In one example, self-referencing detection relies on a model that may be the same as or different from the large language model used to generate the response 156. Whether a current query is self-referencing is determined by a self-reference detection model in one example. The context returned to the context management 152 (e.g., query is self-referencing (true) or not (false)) may influence the manner in which the large language model is queried, which resources are used, or the like. The context management 152 may orchestrate different sessions for the same user. Each session may be a sequence of questions and answers that are separate from other sequences.

As previously stated, context management is complicated by queries that are self-referencing. An example sequence of queries may be:
1. What are the core tools for property-based automated testing currently in use?
2. Can these tools be used for other testing frameworks?
3. Which ones are open source?

Context management for these queries is difficult because a follow-up query (query 3) does not mention the same topics as the previous queries. Context management for these queries is also difficult because it is unclear whether the last query (query 3) refers to the original tools (for property-based testing) in query 1 or the tools that can be used for other testing frameworks in query 2. The ambiguity makes it hard, even for a person, to determine whether the context has changed and whether the query is self-referencing.

Another example sequence of queries may be:
1. What are the main technological challenges in Cloud Computing?
2. Why has Cloud Computing become so central in IT systems?

This sequence of queries illustrates a conversation where the same topic is mentioned in both queries. However, there is a strong possibility that a context change has occurred. Thus, for content retrieval purposes, the set of sources necessary to answer the second query may not intersect with the sources needed to answer the first query. Embodiments of the invention relate to engineering a prompt and to selecting a model to determine whether a query is self-referencing . This decision can impact the selection of sources used to generate the response 156, the input submitted to the large language model used by the chatbot, and the like.

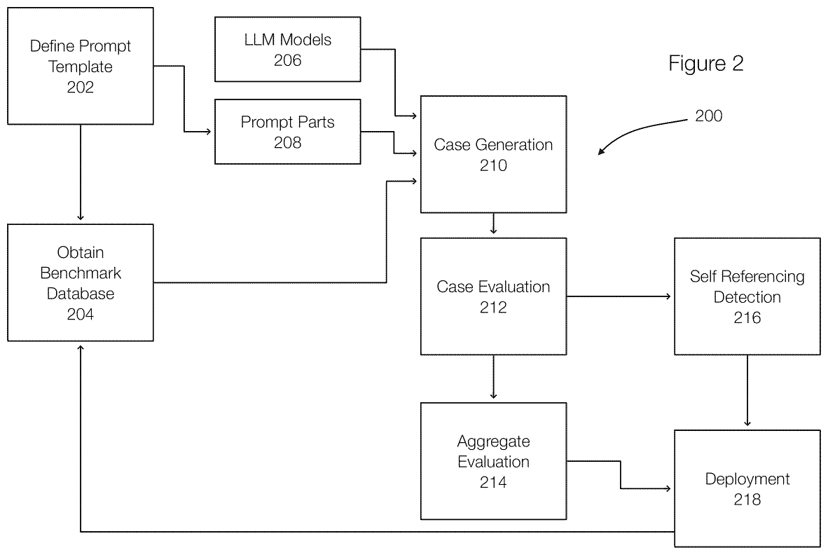

FIG. 2 discloses aspects of a system configured to detect self-referencing queries. FIG. 2 further illustrates aspects of prompt engineering, which may include evaluating multiple models and/or prompt instances to identify a model and/or prompt that is most likely to correctly identify self-referencing queries.

In the system 200, a prompt template is defined 202. The prompt template 202 is filled with selections from prompt parts 208, which may be created by a specialist, user, or other author, and/or extracted from content. The benchmark database is created or obtained 204 and includes examples of conversations or sequences of user queries. The benchmark database 204 may follow a specific definition, may be periodically updated, or the like. The benchmark database 204 may also include information indicating whether a query is related to a reference query. This information may be used to assess or evaluate the ability of a model to determine or predict whether two (or more) queries are related (e.g., one is self-referencing).

Large language models 206 may also be available. The large language models 206 are a group of models being evaluated or assessed regarding their ability to identify a self-referencing query.

The models 206, prompt parts 208, and data from the benchmark dataset 204 may be used to generate 210 a case. Once a case 210 is generated, the case is evaluated 212 or tested. Evaluating 212 the case may include performing self-referencing detection 216 using the models 206. Entries, which include the queries in the benchmark dataset 204 are evaluated as separate cases in one example in the self-referencing detection 216.

By way of example, a case may include a test query and a reference query from the benchmark dataset 204. The test query is known to be related (or not related) to the reference query and is associated with a penalty. The case is then evaluated by one of the models 206. This allows the output of the model to be classified as correct or incorrect. The score of the model is recorded. Thus, an incorrect prediction may be penalized according to the predetermined penalty.

An aggregate score for each of the models 206 may be determined after evaluating all (or at least some) of the cases generated from the benchmark dataset 204. The aggregate evaluation 214 is performed to determine or identify an optimal choice of prompt and model for the benchmark dataset 204. The prompt and self-detection model selected after the aggregate evaluation 214 may be deployed 218 and used in performing context management in, for example, a chatbot application.

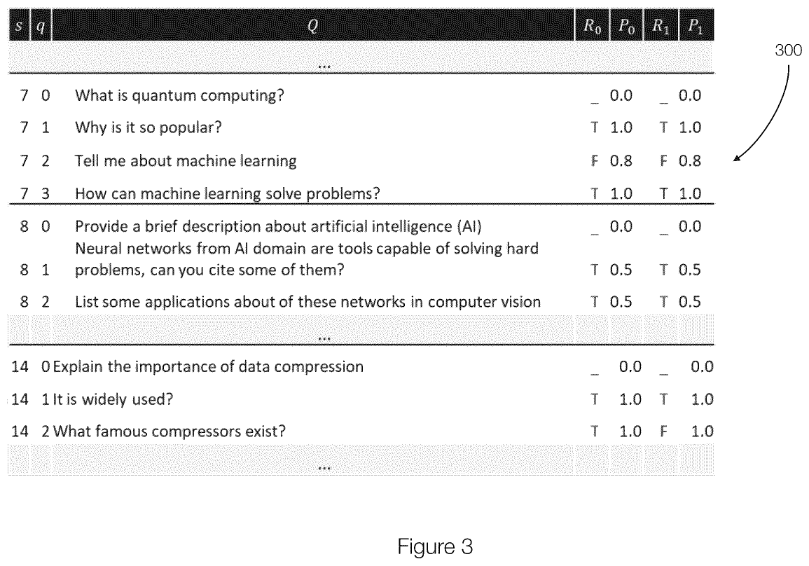

FIG. 3 discloses aspects of a benchmark dataset. The dataset 300 represents interactions between a user and a chatbot (a conversation) and includes information necessary to determine whether the detection model, which may include one or more self-detection mechanisms, is able to correctly identify self-referencing queries. The dataset 300 may be custom built by a user (e.g., in initial iterations), based on human feedback (e.g., in later iterations), feedback from deployment, or the like. As previously indicated, the dataset 300 may allow multiple alternative self-reference detection mechanisms to be evaluated simultaneously. The database may include information related to expected results for multiple detection mechanisms.

The dataset 300 includes a list of queries and associated metrics. The queries Q may be posed to the chatbot. In this example, the responses of the chatbot are not included. However, embodiments of the invention may also incorporate responses into the evaluation.

The dataset 300 (D) is a list of entries (s, q, Q, [symbol] ). In this example, a sequence s in the dataset 300 represents a sequence of a queries Q or questions posed by the user. The portion of the dataset 300 illustrated in FIG. 3 includes sequences 7, 8, and 14. Each sequence represents at least a part of the same conversation between a user and a chatbot. In this example, the queries within a sequence are indexed q. Thus, sequence (s=7) index (q=0) identifies the query “What is quantum computing?” in the dataset 300.

[symbol] is related to self-detection mechanisms and includes an expected result R and a penalty P for each self-detection mechanism includes in the set of self-detection mechanisms [symbol] . In this example, [symbol] =[(R₀, P₀), (R₁, P₁), . . . , (Rₘ>Pₘ)]. Each R represents a ground truth for the corresponding self-referencing mechanism evaluation and may be a Boolean value. Thus, each R indicates whether the current query refers to the reference query (True) or not (False). In this example, P determines the penalty when the model fails to correctly predict whether the query is self-referencing in the context of a particular detection mechanism (indicated by R). The penalty is an example of an error accrued by the self-detection mechanism (or model) when its results do not match R. In this example, the values of P are constrained between 0.0 and 1.0. Thus, the set [symbol] wil contain m tuples (R, P), one for each alternative self-referencing mechanism under consideration.

In this example, D[i][j] is the i-th sequence and j-th row of the sequence. D[i][j]. Q is the j-th query or question in the i-th sequence in the dataset 300. Similarly, d[i][j]. Rₖ and D[i][j]. Pₖ refer to the contents of columns Rₖ and Pₖ in the j-th row, for the k-th mechanism. For example, d[7][1]. Q refers to the query “Why is it so popular?” in the dataset 300.

In one example, the penalty values represent the certainty in the ground truth label. For example, a penalty of 1.0 is assigned to query D[7][1]. P₀ because it is clear that this query references the previous query D[7][0]. However, the query of “Tell me about machine learning” at D[7][2] may be within the context of “quantum computing” in D[7][0]. In this example, the penalty is 0.8. In other words, a lesser penalty is applied if an error is made.

A ground truth value R is not assigned for each query whose index is 0 (q=0) in this example. Embodiments of the invention may not check the first query in a sequence against itself and, as a result, the ground truth may not be needed. The corresponding penalty may not be needed but may be given a value of 0.0.

Each of the mechanisms represents a different algorithm or changes to the deployment that may impact the results. The dataset 300 accounts for two different embodiments of a self-referencing detection algorithm. In this example, the ground truth for D[14][2]. R₀ (True) differs from the ground truth for D[14][2]. R₀ (False). This indicates that different results are expected from these two self detection mechanisms.

Embodiments of the invention are discussed in the context of a single self-referencing detection mechanism and fixed parametrization. Thus, the dataset may be represented as a list of entries (s, q, Q, R, P).

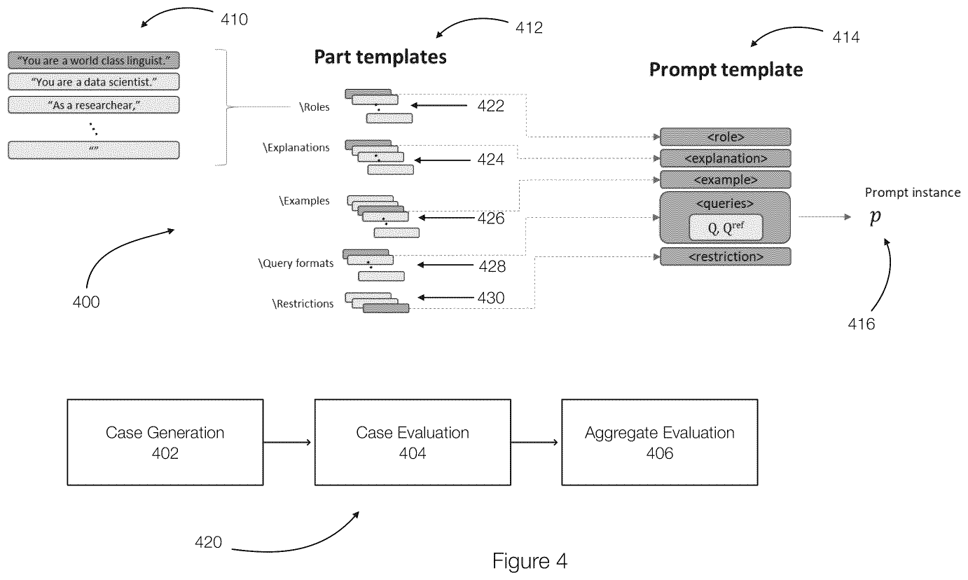

FIG. 4 discloses aspects of a grid search using a benchmark dataset. Once a benchmark dataset, such as the dataset 300 is available, a prompt construction grid search may be performed. The grid search method 420 includes performing case generation 402. FIG. 4 more specifically illustrates aspects of generating 402 a case or a prompt instance 416 in the context of a grid search method 420. FIG. 4 is illustrated by way of example only.

More specifically, FIG. 4 illustrates prompt parts 410, part templates 412 (422, 424, 426, 428, 430), and a prompt template 414. The prompt parts 410 and the part templates 412 may be authored and may vary depending on the domain. In this example, the part templates 412 includes roles, explanations, examples, query formats, and restrictions. When generating a case or prompt instance 416, some of the part templates 412 may be filled using the prompt parts 410. The number of parts included in a prompt instance may vary according to design and are not limited to those discussed herein.

This example illustrates, for the roles 422, a set of prompt parts. One prompt part is selected and entered into the part template 422. Similarly, the part templates 424, 426, and 430 may be filled from corresponding sets of prompt parts 410. For example, the prompt parts (or part instances) for the part template 422 includes “you are a world class linguist”, “you are a data scientist”, “as a researcher”, and an empty string “ ”. This represents 4 possible entries for the “Roles” part templates 422. One of these is selected and input into the prompt template 414. Each of the part templates 424, 426, and 430 may be associated with a similar, but independent, set of prompt parts 410.

In this example, the part template 428 (or the prompt template 414) is filled from the dataset 300. The query format 428 may include space for a test query Q and a reference query Q^{ref} from a sequence in the benchmark dataset. Thus, multiple cases may be generated from each prompt instance for each sequence in the dataset 300, by replacing the test query Q and the reference query Q^{ref} with multiple combinations of test/reference queries from those sequences and/or by selecting other prompt parts 410.

When each of the part templates 412 is filled, a prompt template 414 is ready and is an example of a prompt instance 416.

Thus, for a sequence with 4 queries in the database 300 and assuming there are 4prompt parts defined for each of the part templates 412, there are (4×4×4×4×4)=1024 combinations or cases that may be generated.

FIG. 4 thus illustrates that multiple test cases may be generated from each sequence in the benchmark dataset. The part templates 412 and prompt template 414 can be augmented, reduced, or modified for various reasons including needs of a particular application or task or for prompt refinement based on previous results or dataset updates.

After performing case generation 402 to generate cases, case evaluation 404 is performed. The cases are evaluated using a language model, which may be predetermined, for determining whether a test query Q references a reference query Q^{ref} for a given mechanism. Embodiments of the invention may test multiple different models, which may be examples of self-detection mechanisms.

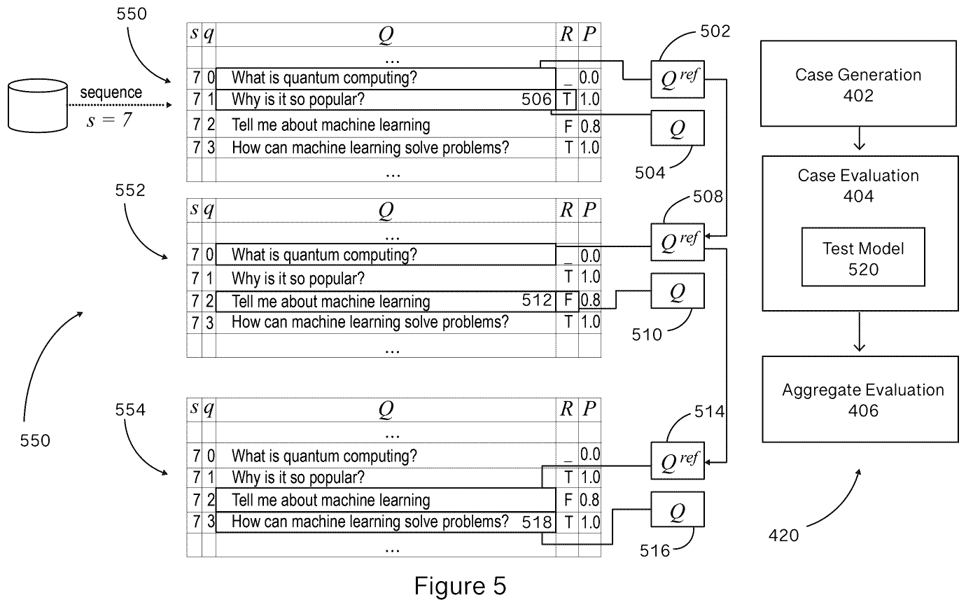

FIG. 5 illustrates aspects of evaluating cases using various combinations of a text query and a reference query in the cases or prompt instances. FIG. 5 illustrates a portion of a dataset 500 (an example of the dataset 300) and illustrates three different test query/reference query pairs 550, 552, and 554. The pair 550 includes queries D[7][0] and D[7][1]. The pair 552 includes queries D[7][0] and D[7][2]. The pair 554 includes queries D[7][2] and D[7][3]. More specifically, FIG. 5 illustrates aspects of sequence 7 and different selections or combinations of a test query and a reference query. In one example, the sequence is processed linearly or in the order of the index q when generating cases.

The pair 550 includes the query D[7][1] as the reference query 502 and the query D[7][2] as the test query 504. The test model 520 may receive a case as input and determine whether the test query 504 is related to or references reference query 502. In other words, the test model 520 may determine whether the test query 504 is a self-referencing query. The expected result 506 of the test model 520 for the test query 502 is true as illustrated by the expected result 506 in the dataset 500. If the test model 520 correctly predicts (true) that the test query 502 is related to or references the reference query, no penalty is assessed. Whether correct or not, a score for the test model 520 is generated and stored.

The next case includes a pair 552 of queries including a reference query 508 and a test query 510. In this example and because the previous case was true, the same reference query 508, which is the same as the reference query 504, is used. The test query 510 is different from the test query 504 in this case. In this example, the test model 520 is expected to predict that the test query 510 is not related (false) to the reference query 508. In other words, the expected result 512 is false. If the test model 520 predicts (true), then the specified penalty of 0.8 is applied. Thus, a score for the case that includes the pair 510/508 is generated and combined with the score from the previous case.

Because the expected result 512 is false, the test query 508 becomes the new reference query and is referenced as the reference query 514 in the pair 554 of queries that includes the reference query 516 and a different test query 516.

More specifically, an expected result 512 of false suggests a change in subject or a change in context and results in a new reference query 514. The expected result 518 of the test model 520 for the pair 554 is true. When deployed, embodiments of the invention can also detect a change in subject based on the self-referencing detection. For example, a prediction of false suggest a change in subject.

The grid search method 420 may be applied for multiple self-detection mechanisms. Each alternative self-detection mechanism may define a specific algorithm for obtaining or evaluating pairs (Q, Q^{ref}) from a sequence of a benchmark dataset. As discussed above, one detection mechanism used query pairs (e.g., pairs 550, 552, 554). Another detection mechanism may consider the responses of the chatbot when determining whether the test query is related to the reference query. In one example, the reference question may be updated by an external mechanism, such as a preprocessing task or operation. In this example, the ground truth may differ compared to what is illustrated.

In one example, the cases generated from the prompt parts, part templates, and prompt template may be evaluated in parallel. Each execution may be evaluating a different detection mechanism. In other words, the detection mechanisms are considered and evaluated separately in one example.

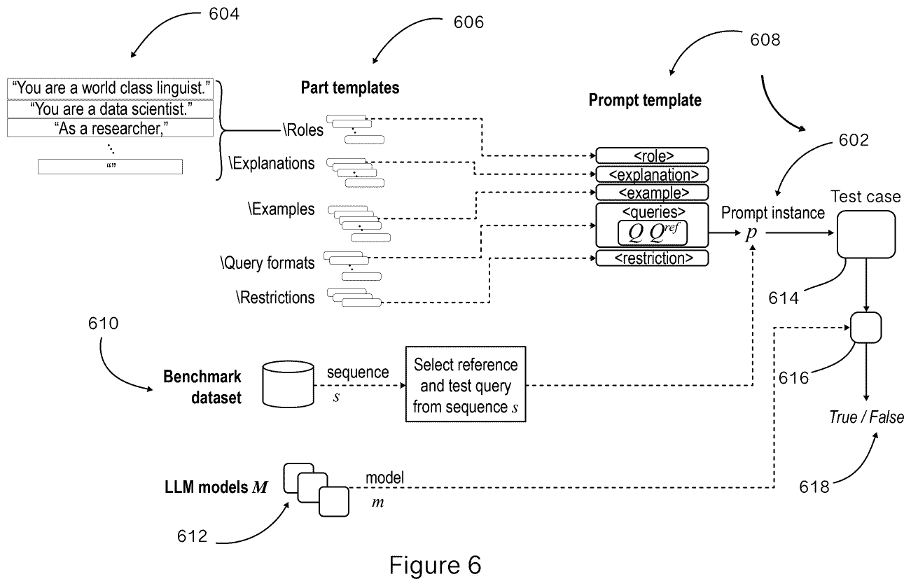

FIG. 6 discloses additional aspects of evaluating a case. FIG. 6 illustrates that a prompt instance 602 is generated as previously described. More specifically, prompt parts 604 are used for the part templates 606. The part templates 606 are used to form the prompt template 608, which is a collection of part templates, and which may be changed. The prompt instance 602 includes a test query and a reference query retrieved from a sequence in the benchmark dataset 610. The resulting test case 614 is then evaluated by being input into a model 616 that is selected from a set of models 612. The prediction 618 can be compared to the expected result and a score for each case/detection mechanism or model is determined.

In one example, a score for case 614 is given by the penalty specified in the benchmark dataset 610. More specifically, let res_{i,j}={1; 0} be a Boolean response from the model m for whether the query Q=D[i][j]. Q references Q^{ref}. The error is defined as follows:

$$E = abs ( re {s}_{i , j} - D [ i ] [ j ] . R ) * D [ i ] [ j ] . P .$$

In other words, a score of 0 is generated with the prediction is the same as the expected result; and the score is the penalty (as defined in the dataset 300) when the prediction is different from the expected result.

The grid search method 420 then performs an aggregate evaluation 406 (see also FIGS. 4-5). The scores for the cases for each detection mechanism are summed in one example and the detection mechanism (or model) with the best score (e.g., lowest) is selected.

Cases can also be evaluated using different prompt templates. Thus, the best prompt can be engineered and selected. The prompt template selected for context management is the prompt template suggested by the aggregate evaluation. More specifically, the grid search method 420 allows a prompt template/self-detection model or algorithm to be selected and deployed to the chatbot.

In one example, the cases can allow various combinations of a prompt instance/detection mechanism to be assessed using the scores to determine which combination performs best overall for the benchmark dataset. The model and prompt instance selected using the scores are deployed for usage in a chatbot. In deployment, the test query is typically the current query, and the reference query is a previous query.

Tracking or determining which query is the reference query when embodiments of the invention are deployed may be performed in various manners. In one example, the reference query is the last query that triggered fetching/accessing of new sources in the content retrieval operation. Feedback provided by users may be tracked and incorporated into a next or updated benchmark dataset.

As sequences are added to the benchmark dataset, it may be possible to remove the oldest sequences. When a sufficient number of sequences have been added, a new grid search method may be triggered to identify an optimum model and prompt instance.

Embodiments of the invention, such as the examples disclosed herein, may be beneficial in a variety of respects. For example, and as will be apparent from the present disclosure, one or more embodiments of the invention may provide one or more advantageous and unexpected effects, in any combination. Some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, context management operations, self-detection, or self-referencing operations, chatbot operations, query related predictions, or the like. More generally, the scope of the invention embraces any operating environment in which the disclosed concepts may be useful.

It is noted that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. generating a first case from a prompt instance, wherein the prompt instance is constructed using part templates, inserting queries from a benchmark database into a first part template included in the prompt instance, the queries including a test query and a reference query, testing the first case with a first model, wherein the first model generates a prediction of whether the test query is self-referencing with respect to the reference query, assigning the test case a first score when the prediction agrees with an expected result associated with the test query or a second score when the prediction does not agree with the expected result.

Embodiment 2. The method of embodiment 1, further comprising testing the first case with a plurality of models including the first model, wherein each of the plurality of models is associated with a different self-detection mechanism.

Embodiment 3. The method of embodiment 1 and/or 2, wherein the expected result is defined in the benchmark database for each of the self-detection mechanisms.

Embodiment 4. The method of embodiment 1, 2, and/or 3, wherein each of the self-detection mechanisms in the benchmark database is associated with a ground truth and a penalty.

Embodiment 5. The method of embodiment 1, 2, 3, and/or 4, wherein the penalty is the second score when the prediction does not agree with the ground truth.

Embodiment 6. The method of embodiment 1, 2, 3, 4, and/or 5, further comprising generating multiple cases from the prompt instance and the benchmark database, wherein each of the multiple cases includes a different pair of queries, wherein one of the pair of queries is a test query and one of the pair of queries is the reference query.

Embodiment 7. The method of embodiment 1, 2, 3, 4, 5, and/or 6, further comprising selecting a new reference query when the expected result associated with a query is false.

Embodiment 8. The method of embodiment 1, 2, 3, 4, 5, 6, and/or 7, further comprising determining an aggregate score for each of multiple models including the first model after evaluating multiple cases with each of the models.

Embodiment 9. The method of embodiment 1, 2, 3, 4, 5, 6, 7, and/or 8, wherein the aggregate scores are related to combinations, each combination including a prompt instance and a model, further comprising selecting a combination from among the combinations deploying the selected combination to an application.

Embodiment 10. The method of embodiment 1, 2, 3, 4, 5, 6, 7, 8, and/or 9, wherein the application comprises a chatbot and wherein the chatbot uses the combination to determine whether a current query received from a user references a reference query previously submitted to the chatbot by the user.

Embodiment 11. The method of embodiment 1, 2, 3, 4, 5, 6, 7, 8, 9, and/or 10, further comprising determining an aggregate score for each of the combinations and selecting the combination with a lowest score for deployment.

Embodiment 12. The method of embodiment 1, 2, 3, 4, 5, 6, 7, 8, 9, 10, and/or 11, wherein an output of the selected model in the combination impacts an input to a large language model configured to generate a response to the current query.

Embodiment 13. A system, comprising hardware and/or software, operable to perform any of the operations, methods, or processes, or any portion of any of these, disclosed herein.

Embodiment 14. A non-transitory storage medium having stored therein instructions that are executable by one or more hardware processors to perform operations comprising the operations of any one or more operations or methods disclosed herein including any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non- transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term client, module, component, engine, service, agent, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

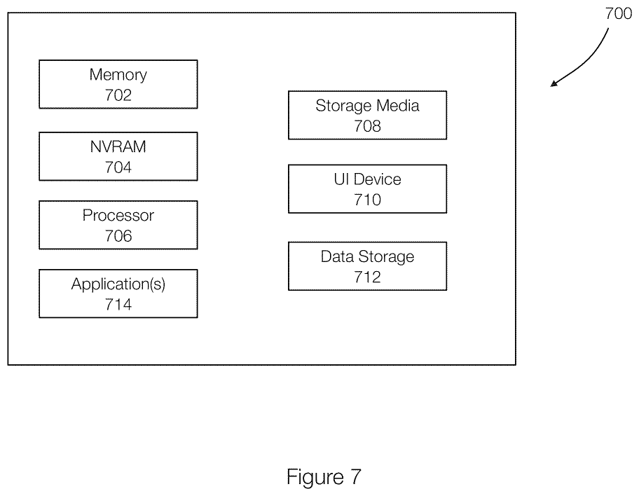

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 701 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
generating a first case from a prompt instance, wherein the prompt instance is constructed using part templates;
inserting queries from a benchmark database into a first part template included in the prompt instance, the queries including a test query and a reference query;
testing the first case with a first model, wherein the first model generates a prediction of whether the test query is self-referencing with respect to the reference query;
assigning the test case a first score when the prediction agrees with an expected result associated with the test query or a second score when the prediction does not agree with the expected result.

2. The method of claim 1, further comprising testing the first case with a plurality of models including the first model, wherein each of the plurality of models is associated with a different self-detection mechanism.

3. The method of claim 2, wherein the expected result is defined in the benchmark database for each of the self-detection mechanisms.

4. The method of claim 3, wherein each of the self-detection mechanisms in the benchmark database is associated with a ground truth and a penalty.

5. The method of claim 4, wherein the penalty is the second score when the prediction does not agree with the ground truth.

6. The method of claim 1, further comprising generating multiple cases from the prompt instance and the benchmark database, wherein each of the multiple cases includes a different pair of queries, wherein one of the pair of queries is a test query and one of the pair of queries is the reference query.

7. The method of claim 6, further comprising selecting a new reference query when the expected result associated with a query is false.

8. The method of claim 1, further comprising determining an aggregate score for each of multiple models including the first model after evaluating multiple cases with each of the models.

9. The method of claim 8, wherein the aggregate scores are related to combinations, each combination including a prompt instance and a model, further comprising selecting a combination from among the combinations deploying the selected combination to an application.

10. The method of claim 9, wherein the application comprises a chatbot and wherein the chatbot uses the combination to determine whether a current query received from a user references a reference query previously submitted to the chatbot by the user.

11. The method of claim 10, further comprising determining an aggregate score for each of the combinations and selecting the combination with a lowest score for deployment.

12. The method of claim 11, wherein an output of the selected model in the combination impacts an input to a large language model configured to generate a response to the current query.

13. A non-transitory storage medium having stored therein instructions that are executable by one or more hardware processors to perform operations comprising:
generating a first case from a prompt instance, wherein the prompt instance is constructed using part templates;
inserting queries from a benchmark database into a first part template included in the prompt instance, the queries including a test query and a reference query;
testing the first case with a first model, wherein the first model generates a prediction of whether the test query is self-referencing with respect to the reference query;
assigning the test case a first score when the prediction agrees with an expected result associated with the test query or a second score when the prediction does not agree with the expected result.

14. The non-transitory storage medium of claim 13, further comprising testing the first case with a plurality of models including the first model, wherein each of the plurality of models is associated with a different self-detection mechanism, wherein the expected result is defined in the benchmark database for each of the self-detection mechanisms and wherein each of the self-detection mechanisms in the benchmark database is associated with a ground truth and a penalty.

15. The non-transitory storage medium of claim 14, wherein the penalty is the second score when the prediction does not agree with the ground truth.

16. The non-transitory storage medium of claim 13, further comprising generating multiple cases from the prompt instance and the benchmark database, wherein each of the multiple cases includes a different pair of queries, wherein one of the pair of queries is a test query and one of the pair of queries in the reference query.

17. The non-transitory storage medium of claim 16, further comprising selecting a new reference query when the expected result is false and determining an aggregate score for each of multiple models including the first model after evaluating multiple modules using the cases.

18. The non-transitory storage medium of claim 17, further comprising selecting a combination from among multiple combinations that each include a prompt instance and a model and deploying the combination to an application.

19. The non-transitory storage medium of claim 18, wherein the application comprises a chatbot and wherein the chatbot uses the combination to determine whether a current query received from a user references a reference query previously submitted by the user.

20. The non-transitory storage medium of claim 19, further comprising determining an aggregate score for each of the combinations and selecting the combination with a lowest score for deployment, wherein an output of the selected model in the combination impacts an input to a large language model configured to generate a response to the current query.
